(19) United States
(12) Patent Application Publication
(10) Pub. No.: US 2007/0013778 A1
(43) Pub. Date: Jan. 18, 2007

(54) Movie antipirating

(76) Inventors: Peter Will, Los Altos Hills, CA (US); Herbert Schorr, Marina Del Rey, CA (US)

Correspondence Address: FISH & RICHARDSON, PC, P.O. BOX 1022, MINNEAPOLIS, MN, 55440-1022, US

(21) Appl. No.: 11/480,332

(22) Filed: Jun. 29, 2006

Related U.S. Application Data
(60) Provisional application No. 60/696,031, filed on Jul. 1, 2005.

(51) Int. Cl. H04N 7/18

(52) U.S. Cl. 348/151; 348/159

(57) ABSTRACT

A movie antipirating scheme associates a detector with a screen and takes video and/or pictures of the audience. The detector can either detect something emitted by the camera or can find an image of a camera in the audience. An output indicative of the location of the probable camera can be used to find the person using the camera in the audience. Eg by detecting his seat number if sitting down or location if the camera has been stashed somewhere. Most likely the camera in front and center to avoid obvious distortion in the features the movie

### CROSS-REFERENCE TO RELATED APPLICATIONS

This application claims priority to U.S. application Ser. No. 60/696,031, filed on Jul. 1, 2005. The disclosure of the prior application is considered part of (and is incorporated by reference in) the disclosure of this application.

### BACKGROUND

Pirating of first run movies may be costly for motion picture producers. A movie can be pirated by making a copy of the movie in various ways while it is being shown to audiences.

One conventional way of making such a copy includes aiming a camera at the movie screen to make a video copy of the movie. The copy formed by the camera is then sold. As camera technology improves, it becomes possible to make better copies of movies in this way. It is also possible to obtain sound by synchronizing with various streams that are provided for hearing and/or sight impaired people, often called Telesync.

### SUMMARY

The present application teaches detecting pirating of movies at the point of playing. Another aspect determines a location of the movie pirating technique.

### BRIEF DESCRIPTION OF THE DRAWINGS

FIG. 1 shows an embodiment of a new movie copying detector.

### DETAILED DESCRIPTION

The general structure and techniques, and more specific embodiments which can be used to effect different ways of carrying out the more general goals, are described herein.

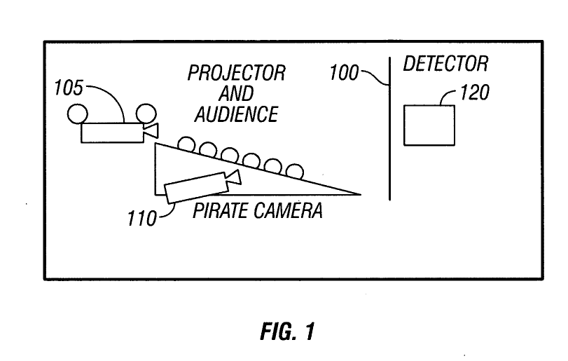

According to one aspect, a new movie copying detector is provided in a location where the movie is being played. FIG. 1 shows an embodiment. A movie screen 100 shows a movie that is being projected by a projector 105. The embodiment assumes that a pirate camera shown as 110 is somewhere in the audience. The pirate camera is taking a video of the movie that is playing on the screen. A pirate camera detector 120 points towards the audience, and detects the pirate camera.

The detector 120 can use any of the detection embodiments described herein. Embodiments include active focus detection, passive detection, and image processing detection. The detector may include an associated processor, that may be local or remote to the theater, and which processes the information obtained by the detector, as described herein.

According to an embodiment, a convenient place to detect copying is within the object being copied. FIG. 1 shows the projector projecting the movie on the screen, and shows the detector 120 which is in the area of the screen. For example, it may be behind the screen extending through a small hole, a “pinhole” in the screen. This may be a special pinhole adapted for the detector. Some screens may be formed of a fine mesh and the existing holes can thus allow the detector to extend therethrough. Alternatively, the detector may be as close to the edge of the screen as reasonably possible. The detector should be as close to the center as possible, since that is where the action is in movies and where the pirate will focus.

The detector typically points at the audience, for example, the detector may point through the pinhole in the center of the screen toward the audience.

A first detection embodiment detects a camera emission. Many cameras, for example, use active focus. Some cameras use, for example, a sonar or ultrasonic signal to focus on the object. For example, since 1986, Polaroid Corp. has used a sonar to bounce a sound wave off the object. In one embodiment, the detector 120 is an ultrasonic wave receiver. The ultrasonic wave receiver may be tuned to receive different kinds of ultrasonic waves, each representing a different kind of camera autofocus.

Since there are only a certain number of different cameras on the market, it is a relatively simple process to detect each of these different kinds of cameras.

Other emissions can also be detected. Some cameras use an infrared beam, and estimate the range from the return reflectance of the beam. 120 may also detect infrared detection, using, for example, a Si and/or GaAs IR detector. A power consumption detection signature can alternatively be detected.

Geometrical techniques are used to determine the position of the camera, once detected.

Another embodiment uses passive detection. Certain cameras use an internal autofocus image processing technique by focusing on highlights in the scene, and adjusting focus accordingly. These cameras may emit no focusing beam. A passive imaging technique may detect passively focused cameras. For example, 120 may include a camera viewing the audience through the screen pinhole. The audience is looking at the screen, and therefore at the sensing camera. The illumination of the audience is oriented axially from the screen towards the audience. The camera may periodically flash the audience with a light pulse. The received image then exhibits the red eye phenomenon for human eyes. Using an analogous principle, illumination from the detector in the middle of the screen may illuminate any cameras in the audience. Any directionality of the illumination provides reflections from highlights in the audience, e.g. from eyes of the audience and also from the reflection from lenses of the pirate camera(s). The passive technique, therefore, uses illumination to detect the reflection from a camera lens. Alternatively, eye reflections will look different spectrally then lens reflections, and therefore can be detected in this way.

The position in the image can be determined, and used to determine the position of the camera.

Another embodiment uses an image processing technique. The system looks continually at the audience and processes the received image. Reflections from the audience will move and change as the individuals in the audience move around, breathe, talk to their neighbors, blink, etc. However, the pirate camera stays in one place. Thus, one technique of image processing averages or otherwise sums many images and looks for the maxima that occur at stationary nodes. Since the pirate camera will be relatively stationary, the stationary nodes are the most likely to represent the pirate cameras. In addition, certain highlights can be searched for, such as shiny reflectors in the auditorium. Permanent highlights from shiny reflectors in the auditorium may be filtered by static clutter detectors used in radar techniques.

Non-anticipated maxima indicate the areas of possible cameras.

The intersection of the ray from the screen camera to the pirate camera intersects the plane of the audience at a certain point which can be considered in a coordinate system such as x,y,z points.

An alternative processing may use a processing kernel which is correlated across the entire image, for example, comparing the image of the audience with known images of lenses and/or cameras, and using that image processing technique to detect the rogue cameras.

However detected, a message is sent to a specified authority, providing the camera position in the auditorium. A high-resolution picture can be sent for analysis along with this detection. The authority can take any appropriate action.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, different camera detection techniques can be used. Also, different camera position techniques may be used, such as placing landmarks in the audience seating area to facilitate location once a camera is sensed. The location of seats in a theater is known. Pirates need to be sitting down, we also know the height of the head of the person sitting down. This provides geometrical points which can be used to calculate information about the locations. This can also be used to measure the motion of the audience. The camera usually remains stationary to prevent making a poor copy. Also, while the above has used motion to detect the camera, it should be understood that any kind of statistic about the audience can be obtained, and the camera(s) will follow a different kind of statistic than the audience. Movement has been described above, other statistics may be brightness/reflectivity, heat generation and/or signature, RF or magnetic outputs (e.g., produced by the motor or by the recording chip(s), sounds (monitoring for a sound indicative of the camera), or any other statistics.

The computers described herein may be any kind of computer, either general purpose, or some specific purpose computer such as a workstation. The computer may be a Pentium class computer, running Windows XP or Linux, or may be a Macintosh computer. The programs may be written in C, or Java, or any other programming language. The programs may be resident on a storage medium, e.g., magnetic or optical, e.g. the computer hard drive, a removable disk or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A method, comprising:
displaying a movie on a screen; and
from a position near said screen, detecting a camera in an audience that is viewing said screen.

2. A method as in claim 1, wherein said position is in a center area of the screen, and views the audience through a small opening in said screen.

3. A method as in claim 1, wherein said detecting comprises detecting a signal emitted by the camera.

4. A method as in claim 3, wherein said signal emitted is an autofocus signal.

5. A method as in claim 1, wherein said detecting detects an image.

6. A method as in claim 5, wherein said image is analyzed to detect an image of a part that is indicative of the camera.

7. A method as in claim 6, wherein said part that is indicative of the camera is an image of a lens.

8. A method as in claim 5, wherein said image is processed to detect an object which remains relatively stationary compared to other objects in the audience.

9. An apparatus, comprising:
a detector that detects an indicia within an audience that is viewing a screen; and
a processor which processes an output signal indicative of a detection carried out by said detector, to detect an object that is likely to be taking a video of contents of the screen.

10. An apparatus as in claim 9, wherein said detector detects an active focusing signal from a camera.

11. A device as in claim 10, wherein said detector and processor detect signatures indicative of specified cameras.

12. A device as in claim 9 wherein said detector is an infrared detector.

13. A device as in claim 9, wherein said detector obtains an image of the audience.

14. A device as in claim 13, wherein said processor processes the image to determine an aspect indicative of a camera in the image.

15. A device as in claim 14, wherein said aspect indicative of the camera is an image of a part which is likely to be a lens.

16. A device as in claim 15, wherein said aspect of the image is an image of a part which has relatively less movement than other parts in the audience.

17. A device as in claim 9, wherein said processor produces an output indicative of a likely position of said object.

18. A method comprising:
using a detector to detect a camera which is pointed at a screen from an audience; and
producing an output which is indicative of a likely position of said camera.

19. A method as in claim 18, wherein said detector detects an output of the camera.

20. A method as in claim 18, wherein said detector takes an image which is processed to detect some aspect of the camera.
